(19) United States
(12) Patent Application Publication
(10) Pub. No.: US 2005/0140594 A1
(43) Pub. Date: Jun. 30, 2005

(54) Semiconductor integrated circuit

(76) Inventor: Atsushi Ishikawa, Nagano-ken (JP)

Correspondence Address: HARNESS, DICKEY & PIERCE, P.L.C., P.O. BOX 828, BLOOMFIELD HILLS, MI, 48303, US

(21) Appl. No.: 10/955,956

(22) Filed: Sep. 30, 2004

(30) Foreign Application Priority Data
Oct. 1, 2003 (JP) 2003-343073

(51) Int. Cl. G09G 3/20; G09G 3/22

(52) U.S. Cl. 345/75.1

(57) ABSTRACT

A semiconductor integrated circuit is provided including first-group anode driving circuits each for outputting a first-group anode voltage to be supplied to first-group anodes that are placed next to each other; second-group anode driving circuits each for outputting a second-group anode voltage to be supplied to second-group anodes that are placed next to each other; and a plurality of selection circuits for, if a control signal is in a first state, inputting the plurality of pulse width modulation signals to the first-group anode driving circuits and inputting a predetermined voltage to the second-group anode driving circuits, and if a control signal is in a second state, inputting the plurality of pulse width modulation signals to the second-group anode driving circuits and inputting a predetermined voltage to the first-group anode driving circuits.

### RELATED APPLICATIONS

This application claims priority to Japanese Patent Application No. 2003-343073 filed Oct. 1, 2003 which is hereby expressly incorporated by reference herein in its entirety.

### BACKGROUND

1. Technical Field

The present invention relates to a semiconductor integrated circuit for driving a vacuum fluorescent display (VFD: fluorescent display tube), and more particularly to a semiconductor integrated circuit (VFD driver) mounted inside a VFD.

2. Related Art

Conventionally, VFDs are used as the flat panel display of calculators, car audio systems, and other devices. In recent years with the trend toward smaller VFD drivers for driving VFDs, a built-in driver VFD (BD VFD) which includes a VFD driver mounted inside the VFD and thus which is capable of driving the VFD directly by using a microprocessor (MPU) or the like has been widely used.

FIG. 7 shows the configuration of a conventional BD VFD. As shown in the drawing, this BD VFD has a display 121 and a VFD driver 122. The VFD driver 122 drives the display 121 based on image data S1 input from an MPU or the like. In the display 121, a plurality of anode groups 123, 124, 125 each including a plurality of anodes A through F aligned in the X-axis direction in the drawing are provided. The plurality of anode groups 123 through 125 are aligned in the Y-axis direction in the drawing. A fluorescent material such as phosphor is applied on each of the anodes A through F.

The plurality of anodes A included in the anode group 123 are coupled to one output terminal of the VFD driver 122. This output terminal supplies a voltage A1 to the anodes A. In the same manner, the anodes B through F included in the anode group 123 are coupled to respective output terminals of the VFD driver 122, each of the terminals supplies voltages B1 through F1 to the anodes B through F, respectively. The same can be said for the anode groups 124 and 125.

Provided above the anode groups 123 through 125 in the Z-axis direction are grids G1 through G7. While grids are reticulated in general, only the outer frame of the grids is shown in FIG. 7 in order to simply describe the configuration of the BD VFD. The grids G1 through G7 are coupled to respective output terminals of the VFD driver 122, each of the terminals supplies voltages G1 through G7 to the grids G1 through G7, respectively.

The BD VFD displays images, in an atmosphere where a high vacuum is maintained by a VFD, by making thermal electrons emitted by a filament (thermal electron source) collide with phosphors applied on the surface of each anode so as to make the phosphors emit light. The phosphors and filament are not shown in FIG. 7.

FIG. 8 is a sectional view of the display including the phosphors and filament. As shown in this drawing, the display 121 (see FIG. 7) includes the filament (thermal electron source) that emits thermal electrons, the plurality of grids G1 through G7 for controlling the thermal electrons emitted by the filament, and the anode groups including the anodes A through F on which a phosphor that emits light when being collided by thermal electrons is applied. The grids G1 through G7 are reticulated, so that accelerating thermal electrons will pass through.

Referring now to FIGS. 7 and 8, the operation of the BD VFD will be described. In this BD VFD, three phosphors placed in the center of two selected grids that are next to each other are made emit light. The whole image is displayed by moving selected grids in the horizontal direction in the drawings one by one, so that three light-emitting phosphors will move.

First, the principle of how phosphors applied on the anodes A through C placed in the center of the grids G3 and G4 emit light will be described. The filament whose temperature has increased in response to applying a voltage emits thermal electrons. The VFD driver 122 applies a voltage that is higher than the voltage applied to the filament to the grids G3 and G4, and thereby accelerating the thermal electrons emitted from the filament to the grids G3 and G4. Here, a voltage that is equal to or lower than the voltage applied to the filament is applied to the grids G1, G2, and G5 through G7, so that the thermal electrons will not be accelerated toward the grids G1, G2, and G5 through G7.

The VFD driver 122 also applies a voltage higher than the voltage applied to the grids G3 and G4 to the anodes A through C, on which selected phosphors for emitting light are applied. Accordingly, the thermal electrons passing through the grids G3 and G4 accelerate and collide with the phosphors. As a result, the phosphors collided by the thermal electrons emit light. In order to prevent part of the thermal electrons passing through the grids G3 and G4 from colliding with non-selected phosphors that are placed near the selected phosphors, a voltage that is equal to or lower than the voltage applied to the grids G3 and G4 is applied to the anodes D through F.

Since the anodes A through C that are not placed in the center of the grids G3 and G4 are coupled to common output terminals to the anodes A through C placed in the center of the grids G3 and G4, the same voltage is applied to the anodes A through C that are not placed in the center of the grids G3 and G4 as the voltage applied to the anodes A through C placed in the center of the grids G3 and G4. However, since a voltage that is equal to or lower than the voltage applied to the filament is applied to the grids G1, G2, and G5 through G7, no thermal electrons pass through the grids G1, G2, and G5 through G7. Accordingly, no thermal electrons collide with the phosphors applied on the anodes A through C that are not placed in the center of the grids G3 and G4.

Therefore, in order to make the phosphors that are placed in the center of the grids G3 and G4 emit light, the VFD driver 122 provides the grids G3 and G4 with a voltage that is higher than the voltage applied to the filament, while it provides the grids G1, G2, and G5 through G7 with a voltage that is equal to or lower than the voltage applied to the filament. Furthermore, the VFD driver 122 provides the anodes A through C with a voltage that is higher than the voltage applied to the grids G3 and G4, while it provides the anodes D through F with a voltage that is equal to or lower than the voltage applied to the grids G3 and G4.

FIG. 9 shows the main configuration of a conventional VFD driver. As shown in FIG. 9, the VFD driver 122 (See FIG. 7) includes flip-flops 126 through 129, latch circuits 130 through 133, a pulse width modulation (PWM) circuit 134, and a driving circuit 135. The flip-flops 126 through 129 shift four-bit data S1 through S4 included in the input data S1 for each of output signals A1 through F1. The latch circuits 130 through 133 individually store the data retained by the flip-flops 126 through 129. The PWM circuit 134 outputs a pulse whose pulse width has been modulated by comparing the data stored by the latch circuits 130 through 133 with predetermined data. The driving circuit 135 outputs an anode voltage based on the pulse signal output from the PWM circuit 134. The anode voltage output from the driving circuit 135 is applied to the anodes A through F through individual output terminals.

Thus the plurality of circuits 126 through 135 are provided to each output terminal. Therefore, even when applying a voltage for turning off to non-selected anodes, it is necessary to input the image data corresponding to the voltage for turning off to the VFD driver 122, and make the plurality of circuits 126 through 135 corresponding to the non-selected anodes operate based on the image data. Accordingly, the conventional VFD driver requires needlessly large-scale circuitry.

Japanese Unexamined Patent Publication No. 2000-206940 (pp. 1, 5, and FIG. 3) describes a liquid crystal display device capable of enhancing display quality by inversely driving a line and pixels to reduce flickers. This liquid crystal display device inversely drives a line when making a display of an interlaced video signal at a high resolution by line-increased driving, so that it can reduce flickers and enhance display quality. Japanese. Unexamined Patent Publication No. 2000-206940, however, does not mention a reduction in circuitry scale in a VFD driver.

In consideration of the above-mentioned issue, the present invention aims to reduce circuitry scale in a semiconductor integrated circuit (IC) that drives a VFD.

### SUMMARY

In order to address the above-mentioned issue, a semiconductor integrated circuit for driving a vacuum fluorescent display based on input image data according to a first aspect of the present invention includes the following: an image data holding circuit for sequentially holding input image data; a plurality of signal generating circuits for generating a plurality of signals based on the image data held by the image data holding circuit; a first-group anode driving circuit for outputting a first-group anode voltage to be supplied to first-group anodes that are placed next to each other in the vacuum fluorescent display; a second-group anode driving circuit for outputting a second-group anode voltage to be supplied to second-group anodes that are placed next to each other in the vacuum fluorescent display; a grid voltage generating circuit for generating a plurality of grid voltages to be supplied to a plurality of grids provided in the vacuum fluorescent display; and a plurality of selection circuits for, if a control signal is in a first state, inputting the plurality of signals generated by the plurality of signal generating circuits to the first-group anode driving circuit and inputting a predetermined voltage to the second-group anode driving circuit, and if a control signal is in a second state, inputting the plurality of signals generated by the plurality of signal generating circuits to the second-group anode driving circuit and inputting a predetermined voltage to the first-group anode driving circuit.

A semiconductor integrated circuit for driving a vacuum fluorescent display based on input image data according to a second aspect of the present invention includes the following: an image data holding circuit for sequentially holding input image data; a plurality of signal generating circuits for generating a plurality of signals based on the image data held by the image data holding circuit; a plurality of anode driving circuits for inputting the plurality of signals generated by the plurality of signal generating circuits, and for outputting a plurality of anode voltages each to be supplied to either first-group anodes that are placed next to each other in the vacuum fluorescent display or second-group anodes that are placed next to each other in the vacuum fluorescent display; a grid voltage generating circuit for generating a plurality of grid voltages to be supplied to a plurality of grids provided in the vacuum fluorescent display; and a plurality of selection circuits for, if a control signal is in a first state, supplying the plurality of anode voltages output by the plurality of anode driving circuits to the first-group anodes and supplying a predetermined voltage to the second-group anodes, and if a control signal is in a second state, supplying the plurality of anode voltages output by the plurality of anode driving circuits to the second-group anodes and supplying a predetermined voltage to the first-group anodes.

Either of the above-mentioned semiconductor integrated circuits may also includes a timing control circuit for outputting a first timing signal for sequentially shifting the image data held by the image data holding circuit, a second timing signal for sequentially inputting the image data held by the image data holding circuit to the plurality of signal generating circuits, and a control signal for controlling the selection circuits. Furthermore, in any one of the above-mentioned semiconductor integrated circuit, each of the plurality of signal generating circuits may be a pulse width modulation circuit for modulating a pulse width based on the image data held by the image data holding circuit.

According to the first aspect of the present invention, it is possible to reduce circuitry scale in the semiconductor integrated circuit (IC) for driving a vacuum fluorescent display by selectively inputting the plurality of signals generated by the plurality of signal generating circuits and a predetermined voltage to the first-group and second-group anode driving circuits. According to the second aspect of the present invention, it is also possible to reduce circuitry scale by selectively supplying the plurality of anode voltages output by the plurality of anode driving circuits and a predetermined voltage to the first-group and second-group anodes.

### BRIEF DESCRIPTION OF THE DRAWINGS

FIG. 1 shows the configuration of a BD VFD using a semiconductor IC according to a first embodiment of the present invention.

FIG. 2 shows the configuration of the semiconductor IC according to the first embodiment of the present invention.

FIG. 3 shows the detailed configuration of the anode voltage generating circuit shown in FIG. 2.

FIG. 4 is a timing chart illustrating the operation of the anode voltage generating circuit.

FIG. 5 shows the configuration of an anode voltage generating circuit included in a semiconductor IC according to a second embodiment of the present invention.

FIG. 6 shows the detailed configuration of the selection circuits shown in FIG. 5.

FIG. 7 shows the configuration of a conventional BD VFD.

FIG. 8 is a sectional view of a display including phosphors and a filament.

FIG. 9 shows the main configuration of a conventional VFD driver.

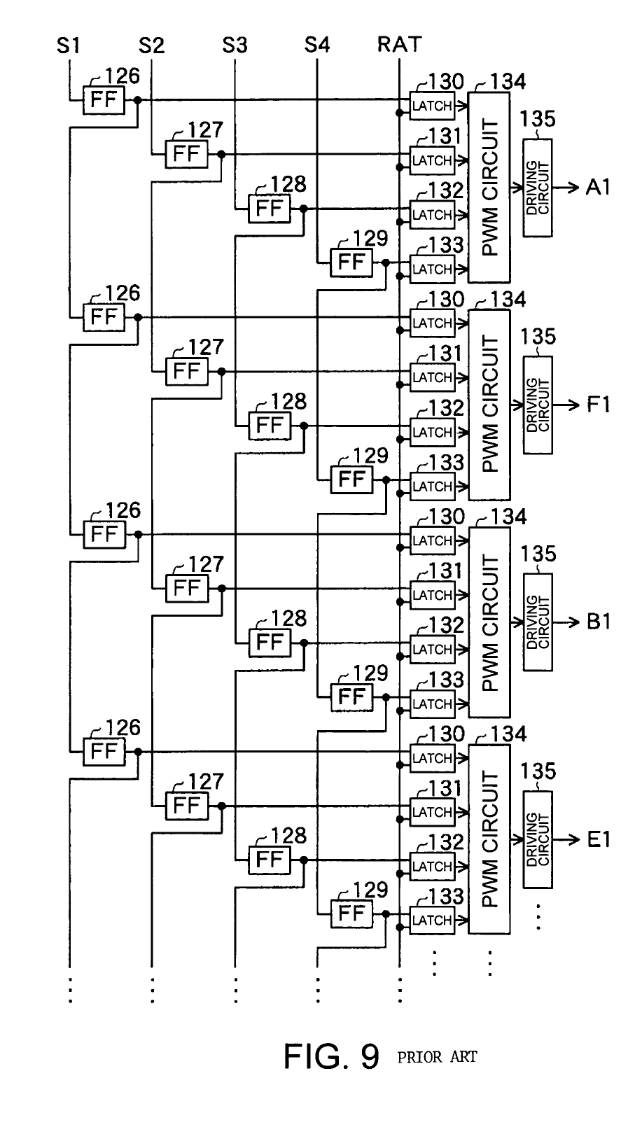

### DETAILED DESCRIPTION

Preferred embodiments of the present invention will now be described with reference to the accompanying drawings. Like reference numerals indicate like parts throughout the drawings, and redundant descriptions will be omitted.

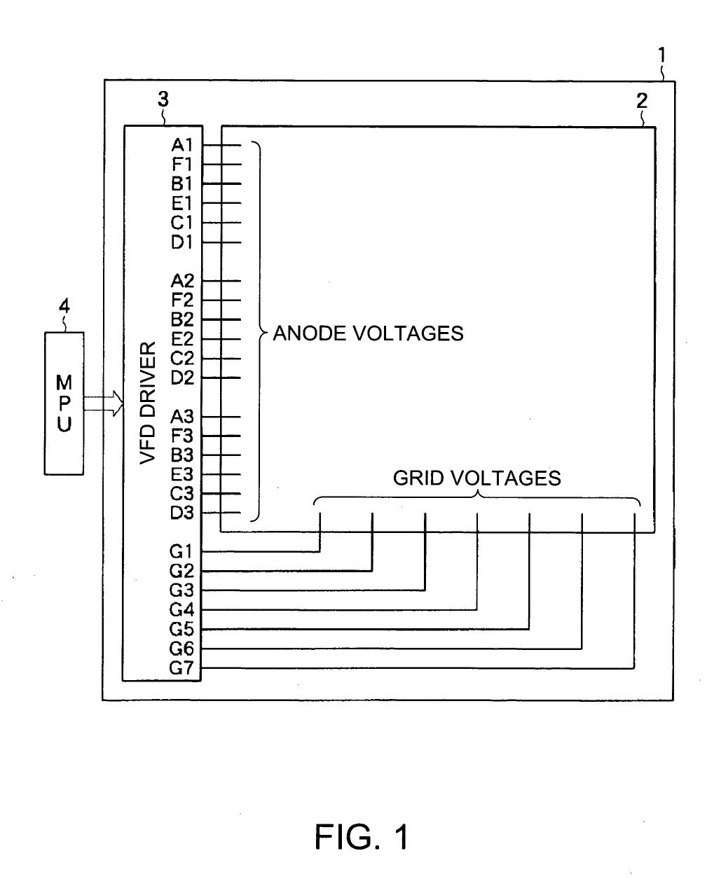

FIG. 1 shows the configuration of a BD VFD using a semiconductor IC according to a first embodiment of the present invention. As shown in this drawing, this BD VFD includes a display 2 formed on a VFD panel 1 made of transparent glass or the like, and a VFD driver 3 mounted on the VFD panel 1. The display 2 is coupled to the VFD driver 3 through a transparent wiring formed on the VFD panel 1.

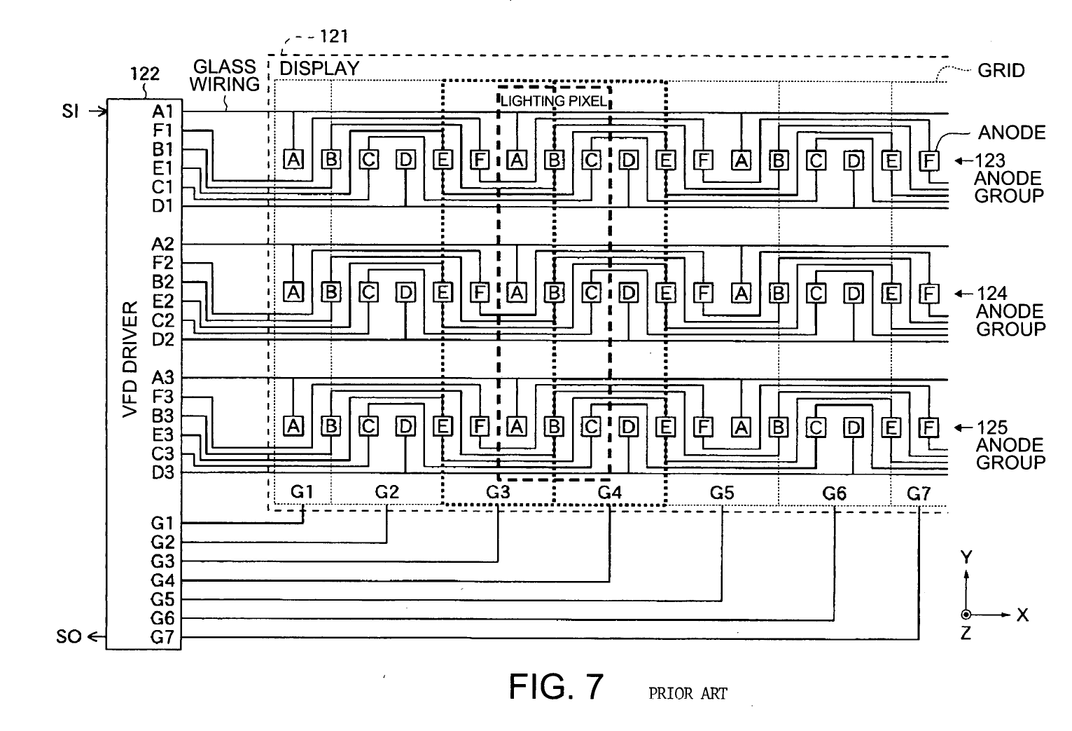

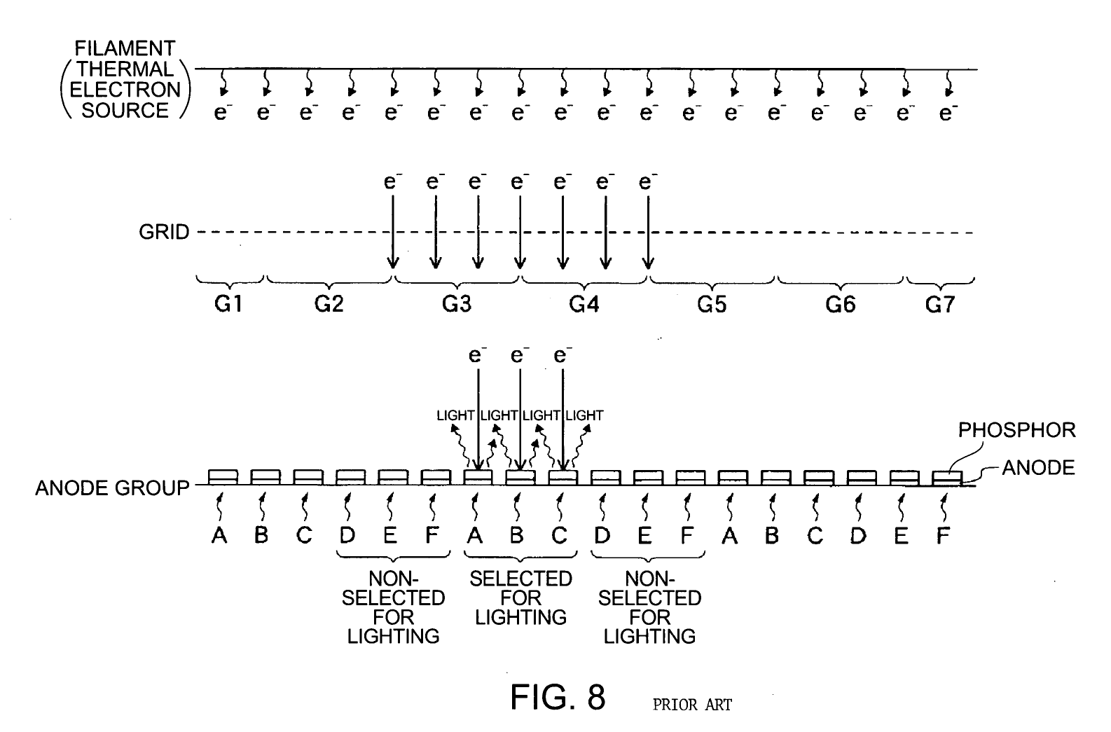

The VFD driver 3 provides a plurality of anodes formed on the display 2 with an anode voltage and provides a plurality of grids formed on the display 2 with a grid voltage in order to drive the display 2. The structure of the display 2 is the same as that shown in FIGS. 7 and 8. An MPU 4 is coupled to the VFD driver 3. Image data output from the MPU 4 are input to the VFD driver 3.

Based on the image data output from the MPU 4, the VFD driver 3 generates anode voltages A1 through F1, A2 through F2, and A3 through F3 to be supplied to the plurality of anodes formed on the display 2, and outputs these voltages from output terminals. The VFD driver 3 also generates grid voltages G1 through G7 to be supplied to the plurality of grids formed on the display 2, and outputs the voltages from output terminals.

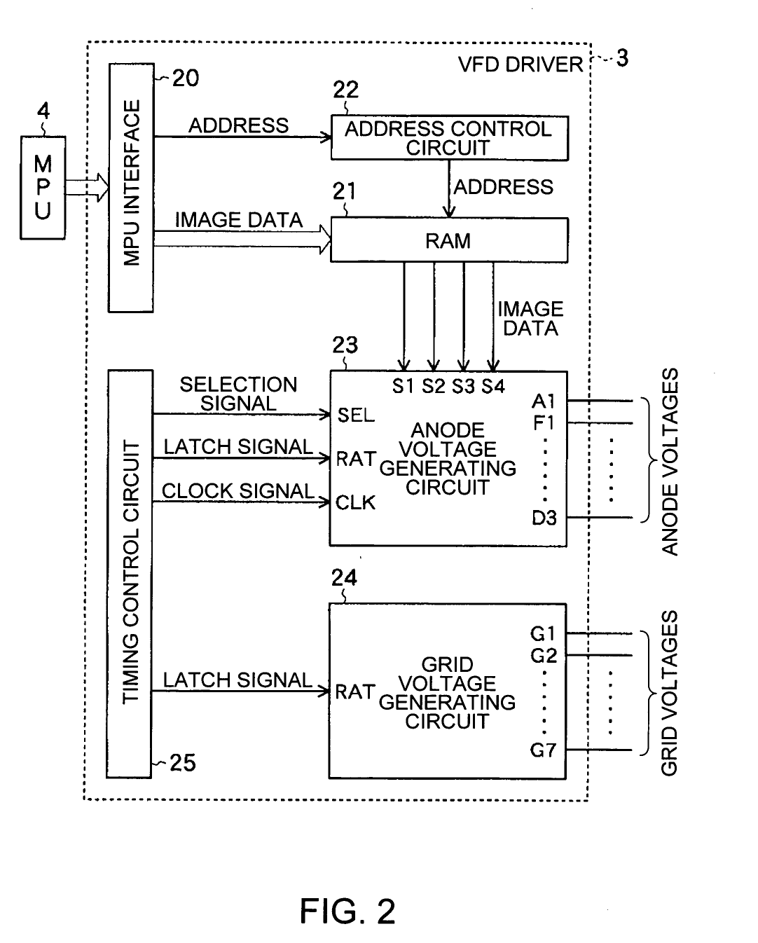

FIG. 2 shows the configuration of the semiconductor IC according to the first embodiment of the present invention. As shown in this drawing, the VFD driver 3 includes an MPU interface 20, a RAM 21, an address control circuit 22, an anode voltage generating circuit 23, a grid voltage generating circuit 24, and a timing control circuit 25. The MPU interface 20 makes a connection with the MPU 4. The RAM 21 stores image data output from the MPU 4. The address control circuit 22 specifies a storage area (address) of image data in the RAM 21 and controls writing and reading of image data. The anode voltage generating circuit 23 generates an anode voltage based on the four-bit image data S1 through S4 read out from the RAM 21. The grid voltage generating circuit 24 generates a grid voltage. The timing control circuit 25 controls the output timing of the anode and grid voltages.

More specifically, the anode voltage generating circuit 23 generates a plurality of anode voltages based on the four-bit image data S1 through S4 read out from the RAM 21, and based on a selection signal SEL, a latch signal RAT, and a clock signal CLK, which are supplied by the timing control circuit 25. The grid voltage generating circuit 24 generates a plurality of grid voltages based on the latch signal RAT input by the timing control circuit 25. The timing control circuit 25 controls the output timing of the anode voltages generated by the anode voltage generating circuit 23, and also controls the output timing of the grid voltages produced by the grid voltage generating circuit 24.

The grid voltage generating circuit 24 outputs two voltages corresponding to two grids that are next to each other out of a plurality of grids in sync with the latch signal RAT. For example, the grid voltage generating circuit 24 first outputs grid voltages G1 and G2, then outputs grid voltages G2 and G3 in sync with the leading edge of the latch signal RAT, and subsequently outputs grid voltages G3 and G4 in sync with the next leading edge of the latch signal RAT. This output process is repeated until grid voltages G6 and G7 are output within a frame period.

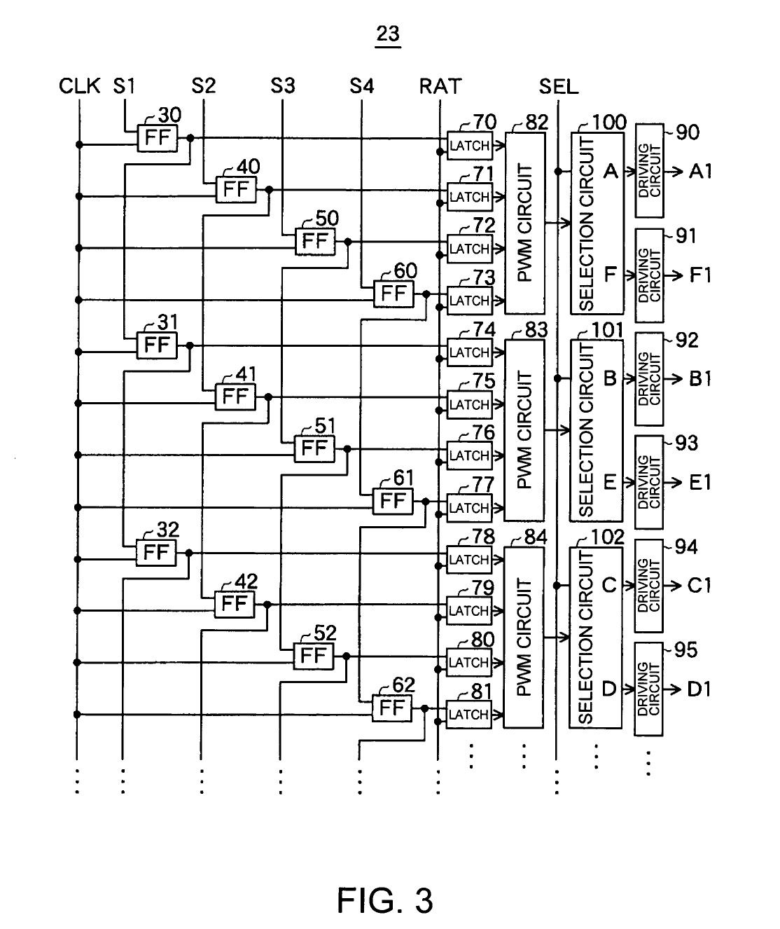

FIG. 3 shows the detailed configuration of the anode voltage generating circuit shown in FIG. 2. As shown in this drawing, the anode voltage generating circuit 23 includes first-group flip-flops 30, 31, and 32, second-group flip-flops 40, 41, and 42, third-group flip-flops 50, 51, and 52, and fourth-group flip-flops 60, 61, and 62. The first-group flip-flops 30, 31, and 32 sequentially shift the image data S1 in sync with the clock signal CLK. The second-group flip-flops 40, 41, and 42 sequentially shift the image data S2 in sync with the clock signal CLK. The third-group flip-flops 50, 51, and 52 sequentially shift the image data S3 in sync with the clock signal CLK. The fourth-group flip-flops 60, 61, and 62 sequentially shift the image data S4 in sync with the clock signal CLK.

The anode voltage generating circuit 23 also includes first-group latch circuits 70, 71, 72, and 73, second-group latch circuits 74, 75, 76, and 77, and third-group latch circuits 78, 79, 80, and 81. The first-group latch circuit 70, 71, 72, and 73 synchronize image data retained by the flip-flops 30, 40, 50, and 60 with the latch signal RAT and store the individual image data. The second-group latch circuits 74, 75, 76, and 77 synchronize image data retained by the flip-flops 31, 41, 51, and 61 with the latch signal RAT and store the individual image data. The third-group latch circuits 78, 79, 80, and 81 synchronize image data retained by the flip-flops 32, 42, 52, and 62 with the latch signal RAT and store the individual image data.

The anode voltage generating circuit 23 also includes PWM circuits 82, 83, and 84. The PWM circuit 82 produces a signal whose pulse width is modulated based on the result of comparing the image data output from the first-group latch circuits 70, 71, 72, and 73 with predetermined data. The PWM circuit 83 produces a signal whose pulse width is modulated based on the result of comparing the image data output from the second-group latch circuits 74, 75, 76, and 77 with predetermined data. The PWM circuit 84 produces a signal whose pulse width is modulated based on the result of comparing the image data output from the third-group latch circuits 78, 79, 80, and 81 with predetermined data.

The anode voltage generating circuit 23 also includes driving circuits 90, 91, 92, 93, 94, and 95 and selection circuits 100, 101, and 102. The driving circuits 90, 91, 92, 93, 94, and 95 output the anode voltages A1, F1, B1, E1, C1, and D1, respectively, based on input signals. The selection circuit 100 outputs the signal produced by the PWM circuit 82 to either one of the driving circuit 90 or the driving circuit 91, and outputs a signal at a low level to the other based on a selection signal SEL. The selection circuit 101 outputs the signal produced by the PWM circuit 83 to either one of the driving circuit 92 or the driving circuit 93, and outputs a signal at a low level to the other based on the selection signal SEL. The selection circuit 102 outputs the signal produced by the PWM circuit 84 to either one of the driving circuit 94 or the driving circuit 95, and outputs a signal at a low level to the other based on the selection signal SEL.

If the driving circuits 90, 92, and 94 output the voltages A1, B1, and C1 for turning on the lighting of the florescent material in the form of phosphors on the anodes A, B, and C, the driving circuits 91, 93, and 95 output the voltages F1, E1, and D1 for turning off the lighting of the phosphors on the anodes F, E, and D. Meanwhile if the driving circuits 91, 93, and 95 output the voltages F1, E1, and D1 for turning on the lighting of the phosphors on the anodes F, E, and D, the driving circuits 90, 92, and 94 output the voltages A1, B1, and C1 for turning off the lighting of the phosphors on the anodes A, B, and C.

Accordingly, one driving circuit coupled to the output sides of each of the selection circuits 100, 101, and 102 applies a voltage to an anode on which a phosphor to be turned on is provided. The other driving circuit applies a voltage to an anode on which a phosphor to be turned off is provided. With this structure, each of the selection circuits 100, 101, and 102, based on the selection signal SEL, outputs signals produced by the PWM circuits to one driving circuit, and outputs a ground potential, for example, to the other driving circuit. This way it is possible to control on and off of lighting for each phosphor. As a result, there is no need for the MPU 4 to output data for turning off the lighting for each phosphor. Thus the memory capacity of the RAM 21 (shown in FIG. 2) can be reduced.

The operation of the anode voltage generating circuit shown in FIG. 3 will now be described. To simplify the description, only the operation of the driving circuits 90 and 91 outputting an anode voltage will be described herein.

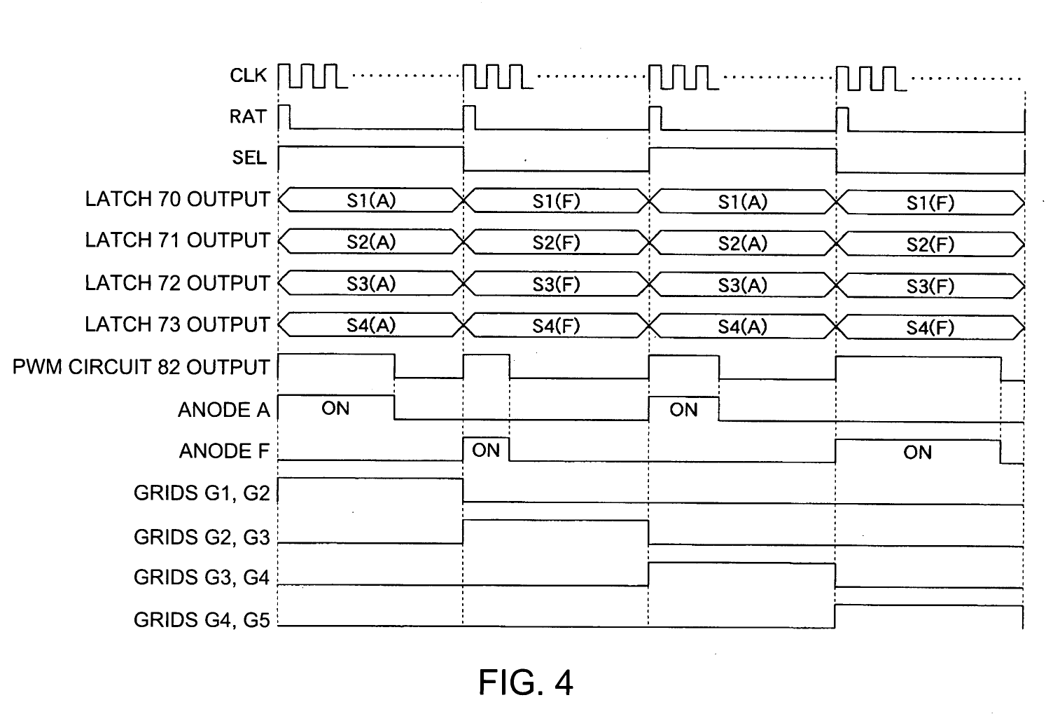

FIG. 4 is a timing chart illustrating the operation of the anode voltage generating circuit. When the flip-flops 30, 40, 50, and 60 shift the four-bit image data S1, S2, S3 and S4, respectively, in sync with the clock signal, the latch circuits 70, 71, 72, and 73 store the image data S1, S2, S3 and S4 retained by the flip-flops 30, 40, 50, and 60, respectively, in sync with the latch signal RAT. The PWM circuit 82 compares the image data retained by the latch circuits 70, 71, 72, and 73 with predetermined data, so as to output a signal whose pulse width is modulated.

Here, when the selection signal SEL is at a high level, the selection circuit 100 outputs the output signal of the PWM circuit 82 to the driving circuit 90 so as to drive the plurality of anodes A, and outputs a signal at a low level to the driving circuit 91 so as to supply the signal to the plurality of anodes F. Meanwhile, when the selection signal SEL is at a low level, the selection circuit 100 outputs the output signal of the PWM circuit 82 to the driving circuit 91 so as to drive the plurality of anodes F, and outputs a signal at a low level to the driving circuit 90 so as to supply the signal to the plurality of anodes A. Also, a grid to which a high voltage is applied changes in sync with the latch signal RAT. Therefore, a phosphor emits light in one of the anodes A or F that corresponds to the grid to which a high voltage is applied.

According to the present embodiment, it is possible to halve the number of flip-flops, latch circuits, and PWM circuits. Moreover, it is possible to drive a VFD panel without inputting data for turning off the lighting of phosphors. Since there is no need to store data for turning off the lighting of phosphors in the RAM, it is possible to halve the storage area for image data in the RAM.

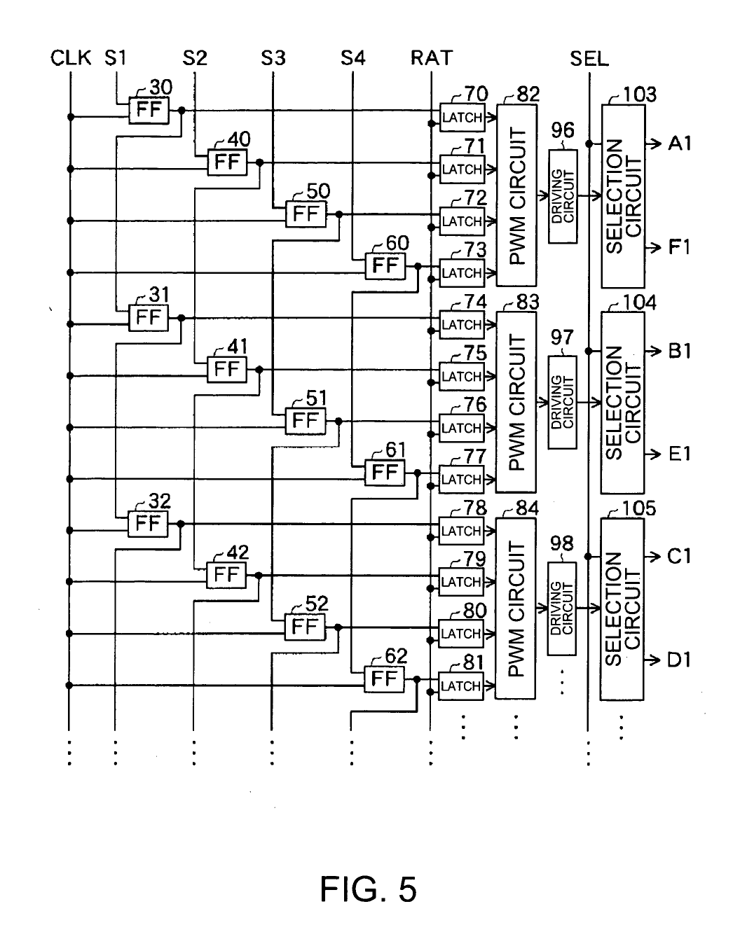

A semiconductor IC according to a second embodiment of the present invention will now be described. FIG. 5 shows the configuration of an anode voltage generating circuit included in the semiconductor IC according to the second embodiment of the present invention. While the anode voltage generating circuit shown in FIG. 3 has the selection circuits before the driving circuits, selection circuits 103, 104, and 105 are placed after driving circuits 96, 97, and 98 in the present embodiment as shown in FIG. 5. Other points of the structure of the semiconductor IC according to the present embodiment are the same as those shown in FIGS. 2 and 3.

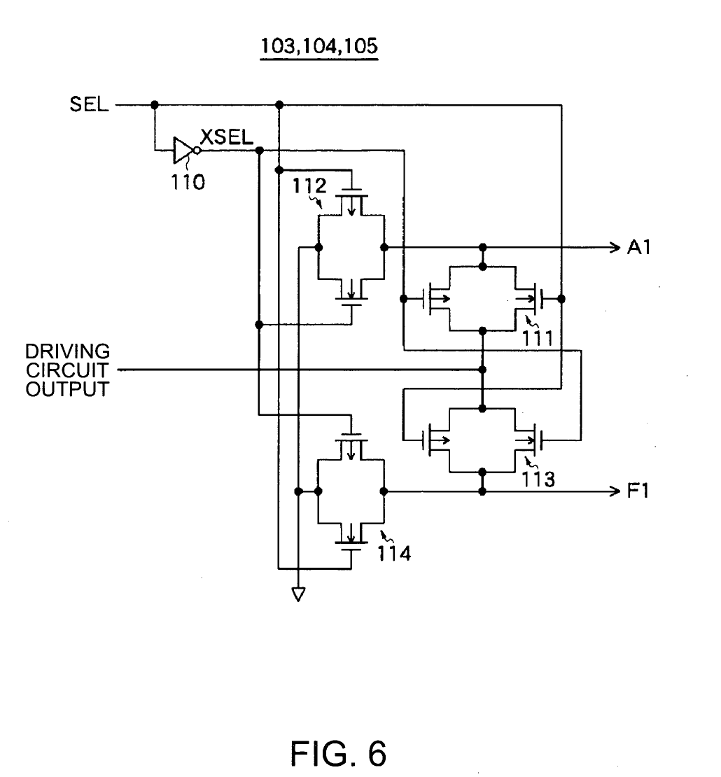

FIG. 6 shows the detailed configuration of the selection circuits shown in FIG. 5. As shown in this drawing, each of the selection circuits 103, 104, and 105 includes an inverter 110 and four analog switches 111, 112, 113, and 114. The inverter 110 inverts the control signal SEL that is input, and outputs an inverted control signal XSEL. The four analog switches 111, 112, 113, and 114 open and close based on the control signal SEL and the inverted control signal XSEL. Each analog switch has one PMOS transistor and one NMOS transistor.

When the control signal SEL is at a high level, the analog switches 111 and 114 turn on while the analog switches 112 and 113 turn off, and thereby supply an output signal of the driving circuit as the anode voltage A1 to the anode A, and supplying a ground potential as the anode voltage F1 to the anode F.

Meanwhile, when the control signal SEL is at a low level, the analog switches 112 and 113 turn on while the analog switches 111 and 114 turn off, and thereby supplying an output signal of the driving circuit as the anode voltage F1 to the anode F, and supplying a ground potential as the anode voltage A1 to the anode A.

According to the present embodiment, it is possible to halve the number of driving circuits, as well as flip-flops, latch circuits, and PWM circuits.

1. A semiconductor integrated circuit for driving a vacuum fluorescent display based on input image data, comprising:
an image data holding circuit holding input image data;
a plurality of signal generating circuits generating a plurality of signals based on the image data held by the image data holding circuit;
a first-group anode driving circuit outputting a first-group anode voltage to be supplied to first-group anodes that are placed next to each other in the vacuum fluorescent display;
a second-group anode driving circuit outputting a second-group anode voltage to be supplied to second-group anodes that are placed next to each other in the vacuum fluorescent display;
a grid voltage generating circuit generating a plurality of grid voltages to be supplied to a plurality of grids provided in the vacuum fluorescent display; and
a plurality of selection circuits inputting the plurality of signals generated by the plurality of signal generating circuits to the first-group anode driving circuit and inputting a predetermined voltage to the second-group anode driving circuit, if a control signal is in a first state.

2. The semiconductor integrated circuit according to claim 1, wherein:
the plurality of selection circuits input the plurality of signals generated by the plurality of signal generating circuits to the second-group anode driving circuit and input a predetermined voltage to the first-group anode driving circuit, if the control signal is in a second state.

3. The semiconductor integrated circuit according to claim 2, wherein the predetermined voltage further comprises a ground voltage.

4. The semiconductor integrated circuit according to claim 1, wherein the predetermined voltage further comprises a ground voltage.

5. A semiconductor integrated circuit for driving a vacuum fluorescent display based on input image data, comprising:
an image data holding circuit holding input image data;
a plurality of signal generating circuits generating a plurality of signals based on the image data held by the image data holding circuit;
a plurality of anode driving circuits inputting the plurality of signals generated by the plurality of signal generating circuits, and for outputting a plurality of anode voltages each to be supplied to either first-group anodes that are placed next to each other in the vacuum fluorescent display or second-group anodes that are placed next to each other in the vacuum fluorescent display;
a grid voltage generating circuit generating a plurality of grid voltages to be supplied to a plurality of grids provided in the vacuum fluorescent display; and
a plurality of selection circuits supplying the plurality of anode voltages output by the plurality of anode driving circuits to the first-group anodes and supplying a predetermined voltage to the second-group anodes, if a control signal is in a first state.

6. The semiconductor integrated circuit according to claim 5, wherein:
the plurality of selection circuits supply the plurality of anode voltages output by the plurality of anode driving circuits to the second-group anodes and supply a predetermined voltage to the first-group anodes, if a control signal is in a second state.

7. The semiconductor integrated circuit according to claim 6, wherein the predetermined voltage further comprises a ground voltage.

8. The semiconductor integrated circuit according to claim 5, wherein the predetermined voltage further comprises a ground voltage.

9. The semiconductor integrated circuit according to claim 1, further comprising:
a timing control circuit for outputting a first timing signal for sequentially shifting the image data held by the image data holding circuit, a second timing signal for sequentially inputting the image data held by the image data holding circuit to the plurality of signal generating circuits, and a control signal for controlling the selection circuits.

10. The semiconductor integrated circuit according claim 1, wherein each of the plurality of signal generating circuits is a pulse width modulation circuit for modulating a pulse width based on the image data held by the image data holding circuit.

11. The semiconductor integrated circuit according to claim 5, further comprising:
a timing control circuit for outputting a first timing signal for sequentially shifting the image data held by the image data holding circuit, a second timing signal for sequentially inputting the image data held by the image data holding circuit to the plurality of signal generating circuits, and a control signal for controlling the selection circuits.

12. The semiconductor integrated circuit according claim 5, wherein each of the plurality of signal generating circuits is a pulse width modulation circuit for modulating a pulse width based on the image data held by the image data holding circuit.

13. A semiconductor integrated circuit for driving a vacuum fluorescent display based on input image data, comprising:
an image data holding circuit holding input image data;
a plurality of signal generating circuits generating a plurality of signals based on the image data held by the image data holding circuit;
a plurality of anode driving means for providing a plurality of anode voltages to first-group anodes and second group anodes that are placed next to each other in the vacuum fluorescent display;
a grid voltage generating circuit generating a plurality of grid voltages to be supplied to a plurality of grids provided in the vacuum fluorescent display; and
selection means for:
providing a first voltage to the first-group anodes and providing a ground voltage to the second group anodes, if a control signal is in a first state;
providing the first voltage to the second group anodes and providing the ground voltage to the first group anodes, if the control signal is in a second state.
